(19) United States
(12) Patent Application Publication
(10) Pub. No.: US 2024/0242155 A1
(43) Pub. Date: Jul. 18, 2024

(54) WORKLOAD HEALTH STATE MONITORING

(71) Applicant: Dell Products L.P., Round Rock, TX (US)

(72) Inventors: Gabriel D. Stern, Austin, TX (US); Stephanos S. Heracleous, Leander, TX (US)

(21) Appl. No.: 18/154,507

(22) Filed: Jan. 13, 2023

(51) Int. Cl. G06Q 10/0637; G06F 11/07

(52) U.S. Cl. CPC G06Q 10/06375; G06F 11/0781; G06F 11/0793

(57) ABSTRACT

Technology described herein relates to managing hardware device health related to a workload that is executable at an operation system. A system can comprise a processor, and a memory that stores executable instructions that, when executed by the processor, facilitate performance of operations, comprising tagging a hardware device of an operation system relative to a workload executable at the operation system, wherein the hardware device is employable to execute the workload at the operation system, and based on a performance indicator that corresponds to a change in status of the hardware device, generating business impact data representative of a business impact corresponding to an effect of the change in the status of the hardware device on the execution of the workload.

### BACKGROUND

Management of an operation system comprising hardware devices can include determining which one or more of the hardware devices, such as control components (e.g., services, consoles and/or plugins), are to perform an operation at the operation system. Often, two or more such hardware devices can be engaged to cooperatively perform a same operation. An operation can comprise execution of a workload. A stakeholder entity, which is monitoring or is responsible for the workload, can employ an operation management system to track the health and performance of the hardware devices executing the workload. However, the stakeholder entity need first be aware of which hardware devices of plural hardware devices of the operation system that are being employed to execute the workload. This information can be that which a stakeholder entity does not have. For example, a stakeholder entity can be a business professional or management professional having no access to the operation system or to the actual execution of the workload. As a result, such stakeholder entity, even if having access to the operation management system, can be unable to track the health and/or performance of the operation system components assigned to the workload.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

An example system can comprise a processor, and a memory that stores executable instructions that, when executed by the processor, facilitate performance of operations, comprising tagging a hardware device of an operation system relative to a workload executable at the operation system, wherein the hardware device is employable to execute the workload at the operation system, and based on a performance indicator that corresponds to a change in status of the hardware device, generating business impact data representative of a business impact corresponding to an effect of the change in the status of the hardware device on the execution of the workload.

An example method can comprise tagging, by the system, relative to a workload executable by an operation system, a hardware device of the operation system that is employable to execute the workload; and prior to a failure of execution of the workload due to a change in health of the hardware device, performing, by the system, a corrective action associated with a type of the failure, wherein performing the corrective action maintains the execution of the workload.

An example non-transitory computer-readable medium can comprise executable instructions that, when executed by a processor, can facilitate performance of operations. The operations can comprise weighting a first workload for execution at an operation system, as compared to a second workload for execution at the operation system, wherein the weighting of the first workload is based on a business impact criterion for the first workload, and wherein the business impact criterion comprises a criticality level of the first workload or a monetary amount assigned to the first workload, and generating a status report representative of a status of the first workload and comprising a suggested action for the execution of the first workload, wherein the suggested action is based on a weight of the first workload resulting from the weighting of the first workload.

An advantage of one or more of the above-indicated method, system and/or non-transitory computer-readable medium can be an enhancement to hardware health monitoring and management to better understand business and/or cost implications of hardware issues on business-critical workloads. In this way, execution of a workload can be tracked separately from mere discrete tracking of individual hardware devices.

Another advantage of one or more of the above-indicated method, system and/or non-transitory computer-readable medium can be proactive notification of a change in status of a workload, relative to one or more hardware devices of an operation system supporting the workload. In this way, a workload's health, and not merely discrete health statuses of hardware devices, can be tracked prior to catastrophic failure of a workload.

Still another advantage of one or more of the above-indicated method, system and/or non-transitory computer-readable medium can be allowance of tracking of a status of a workload by an entity lacking access to hardware management of hardware devices being employed to execute the workload. Indeed, a stakeholder entity can be a business professional or management professional having no access to the operation system or to the execution of the workload. As a result, such stakeholder entity can be able to track the health and/or performance of the workload, even absent any understanding of the hardware devices being employed to execute the workload.

Yet another advantage of one or more of the above-indicated method, system and/or non-transitory computer-readable medium can be generation of one or more policies for addressing a hardware device issue. The policy can be based on one or more workloads employing the hardware device, rather than merely on the hardware device itself. That is, such policies can be determined outside of a vacuum of mere hardware support/management only.

### BRIEF DESCRIPTION OF THE DRAWINGS

The technology described herein is illustrated by way of example and not limited in the accompanying figures in which like reference numerals indicate similar elements.

FIG. 1 illustrates a block diagram of an operation system in combination with a workload management system, in accordance with one or more embodiments and/or implementations described herein.

FIG. 2 illustrates a block diagram of a workload management system, in accordance with one or more embodiments and/or implementations described herein.

FIG. 3 illustrates a block diagram of another workload management system, in accordance with one or more embodiments and/or implementations described herein.

FIG. 4 illustrates a block diagram of inputs for policy generation by the workload management system of FIG. 3, in accordance with one or more embodiments and/or implementations described herein.

FIG. 5 illustrates a process flow diagram resulting in policy generation by the workload management system of FIG. 3, in accordance with one or more embodiments and/or implementations described herein.

FIG. 6 illustrates another process flow diagram illustrating application of a policy engine of the workload management system of FIG. 3, in accordance with one or more embodiments and/or implementations described herein.

FIG. 7 illustrates a graphical user interface that can be generated by the workload management system of FIG. 3 to provide information to a stakeholder entity associated with a workload being managed by the workload management system, in accordance with one or more embodiments and/or implementations described herein.

FIG. 8 illustrates a process flow diagram of a method of workload management by the workload management system of FIG. 3, in accordance with one or more embodiments and/or implementations described herein.

FIG. 9 illustrates a block diagram of an example operating environment into which embodiments of the subject matter described herein can be incorporated.

FIG. 10 illustrates an example schematic block diagram of a computing environment with which the subject matter described herein can interact and/or be implemented at least in part.

### DETAILED DESCRIPTION

### Overview

The technology described herein is generally directed towards management of one or more workloads that can employ one or more hardware devices to achieve execution of the one or more workloads. Policies and corrective actions can be generated and subsequently applied on a workload-basis. The policies and corrective actions can be directed to addressing hardware device-based issues, in a manner that enables overall workload status to take precedence over any individual hardware device status.

That is, for an existing hardware management system, such system can monitor hardware health and/or other statuses of managed hardware devices. However, corrective actions are conventionally taken on a reactive basis and relative only to consideration of each hardware device discreetly. Indeed, information is missing relative to what workload the hardware devices correspond, and thus such existing hardware management systems lack any consideration of status of a workload (e.g., on a workload-based level).

That is, workloads can migrate in time between resource groups of hardware devices, complicating correlation to hardware devices, which is not considered in the first instance.

Further complicating accurate tracking on a workload basis, hardware device issue and/or failure alone does not often convey a full cost of loss. This can be because hardware devices can be associated with plural workloads and/or can migrate between resource groups.

Indeed, it can be desirable to understand how statuses of underlying hardware devices can affect the overlying workloads that are to be deployed and/or already deployed. Such information could guide a decision process of how quickly and/or efficiently to address a hardware device issue, based on resultant loss that correlates to workload execution, such as monetary loss, time loss and/or the like of a workload.

For example, consider an example where a hardware management system tracks statuses (health, connectivity and/or power) of a plurality of hardware devices. Consider where a first hardware device has reduced output but maintains functionality. Consider also where a second hardware device has critically failed and is no longer functional. On a hardware-only basis, it may be optimal to first focus on replacing the second hardware device that is non-functional. However, if workloads were to be considered, it may instead be the case that a higher criticality level is correlated to the first hardware device based on its assignment to a first workload. Such considerations, among many others, are not taken into account by existing hardware management systems.

As another challenge, hardware devices can be conventionally grouped based on factory line, product line, room location and/or the like. However, it can be the case that a first workload can employ a first resource group comprising hardware devices at a plurality of factory lines, product lines and/or room locations. Accordingly, corrective actions suggested and/or taken relative to such hardware devices are conventionally based on the factory line, product line and/or room location. Instead, from a criticality, business impact and/or monetary standpoint, it can be more efficient to otherwise address hardware device issues based on workloads employing such hardware devices.

To account for one or more of the aforementioned deficiencies with existing hardware management systems, a framework is defined herein in one or more embodiments to address hardware device issues based on overlying workload criticality. That is, such framework can monitor/manage the status of a workload based on the underlying hardware infrastructure configured to support the workload, viewed on a workload-first basis.

That is, a plurality of hardware devices can be grouped according to use with a workload. Such grouping can be digital rather than physical. The resultant resource group of hardware devices can be tagged relative to the workload. The workload can have assigned thereto a business impact criterion which can comprise a criticality level and/or monetary amount associated with the workload.

One or more policies for proactively addressing a change in workload status can be generated along with one or more corrective actions for addressing such status. The one or more policies can be based on the business impact criterion of workload, and thus on the criticality level and/or associated monetary amount.

The corrective actions can comprise a notification, report, action performance and/or action suggestion. Exemplary corrective actions, without being limiting, can comprise parts replacement dispatch, power reduction action, connectivity change action and/or swapping of a hardware device. Such corrective actions can directly address one or more hardware devices or even a resource group comprising plural hardware devices. That is, the policies can directly affect hardware device status, based first on workload status.

Further, workload status can be monitored. In response to a negative change in status, a policy can be applied, thus resulting in a corrective action corresponding to the policy being applied. In this way, workload status can be proactively monitored and addressed in a manner that can address hardware device issues apart from mere discrete hardware device-only considerations. Such paradigm shift can allow for enhanced execution of workloads and resultant outputs.

Put another way, one or more embodiments described herein introduce the concept of workload status-based (e.g., health-based) monitoring that can allow a stakeholder entity, such as an administrator entity, to manage/monitor hardware based on mapped workloads and correspondingly view the potential and actual impact on those workloads. For example, the one or more embodiments can proactively alert IT admins of issues, before the hardware is in a catastrophically failed state that would cause a workload failure impacting the bottom line of a business.

Indeed, the one or more embodiments described herein introduce a concept of assignment and management of workloads on a subset of the managed hardware devices where policies can be configured to determine the metrics that can be used to trigger different corrective actions, including methods of notification. The one or more embodiments can comprise one or more processes such as, but not limited to, introducing a workload state monitoring policy, assigning a workload corrective action to a policy, mitigating the impact of a hardware failure on a workload by application of a workload state monitoring policy (also herein referred to simply as a policy), notifying a stakeholder entity of a business impact on a workload, employing defined heuristics to determine the business impact, and/or notifying a stakeholder entity of a workload downtime cost estimation relative to hardware failure and/or reduced performance.

The one or more embodiments described herein can be employed cooperatively with an operation system that comprises one or more computing systems having one or more hardware devices. In one or more cases, an operation system can comprise one or more manufacturing devices, such as assembly-based devices of a product manufacturing line.

The one or more embodiments described herein can be employed to manage one or more workloads prior to workload execution, during workload execution, and/or even post execution where applicable.

### Terminology

As used herein, the term “cost” can refer to power, money, memory and/or processing power.

As used herein, the term “data” can comprise “metadata.”

Reference throughout this specification to “embodiment,” “one embodiment,” “an embodiment,” “one implementation,” and/or “an implementation,” means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, the terms “employing” or “employed by” can refer to an element (e.g., a hardware device) that is currently being employed, that has already been employed and/or that is to be employed.

As used herein, the term “entity” can refer to a machine, device, smart device, component, hardware, software and/or human.

A “group” can refer to a subset of hardware devices of an operation system, which hardware devices can comprise, but are not limited to, storage nodes, switch nodes, server nodes and/or assembly devices, and which operation system can comprise one or more computing systems.

A “hardware controller” or “management console” can be software, such as an application, that can facilitate comprehensive lifecycle management for different types of managed hardware devices.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “power” can refer to electrical and/or other source of power available to the operation system.

As used herein, the term “resource” can refer to power, money, memory, bandwidth, processing power, hardware and/or software.

### Example Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

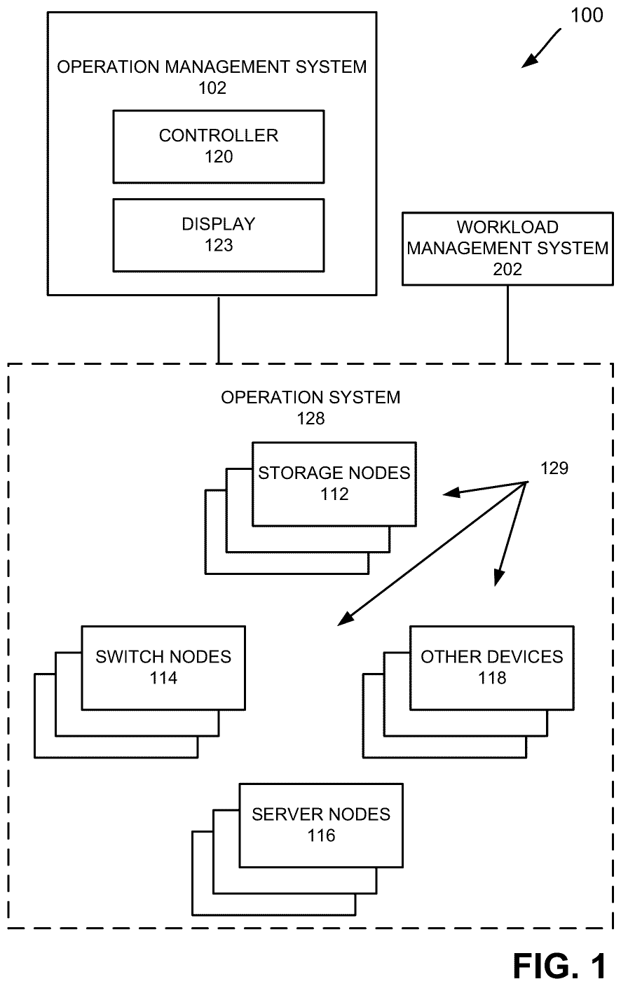

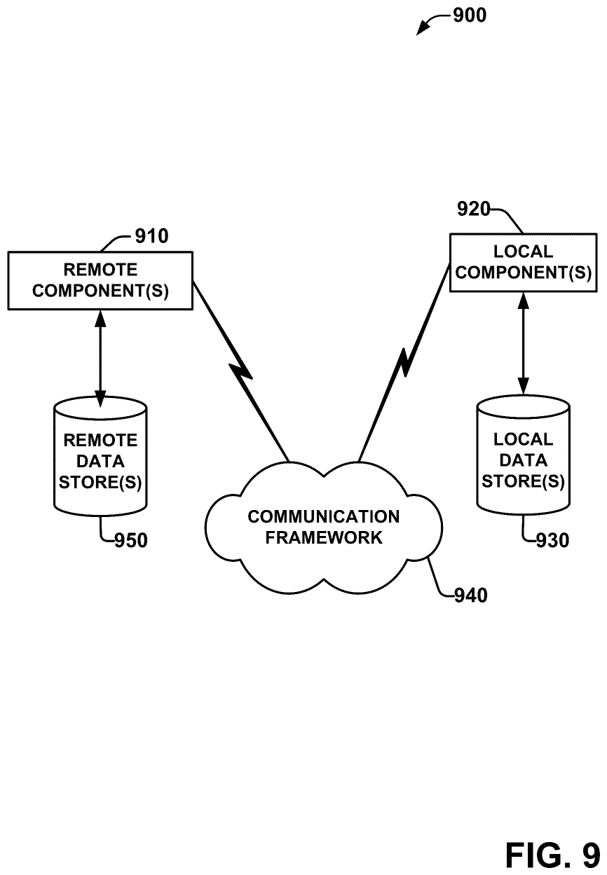

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 900 illustrated at FIG. 9. In one or more described embodiments, computer and/or computing-based elements can be used in connection with implementing one or more of the systems, devices, components and/or computer-implemented operations shown and/or described in connection with FIGS. 1-8 and/or with other figures described herein.

Turning first to FIG. 1, an architecture 100 is illustrated comprising an operation system 128, an operation management system 102, and a workload management system 202 in accordance with one or more embodiments described herein. In one or more embodiments, the workload management system 202 can be supplemented by and/or replaced by the workload management system 302 to be described below.

Briefly, the operation management system (OMS) 102 can comprise at least a controller 120, which can comprise any one or more of an application, software, hardware, processor and/or memory. The controller 120 can be comprised by a processor and/or be a software-type controller. The OMS 102 further can comprise a display 123 for displaying information provided by the OMS 102, such as relative to one or more hardware devices 129 of the operation system 128 operatively coupled to and controlled by the OMS 102.

The operation system 128 can comprise plural hardware devices 129 (e.g., components) such as storage nodes 112, switch nodes 114, server nodes 116 and/or other devices 118. In one or more embodiments, the other devices can comprise a manufacturing device and/or an assembly device.

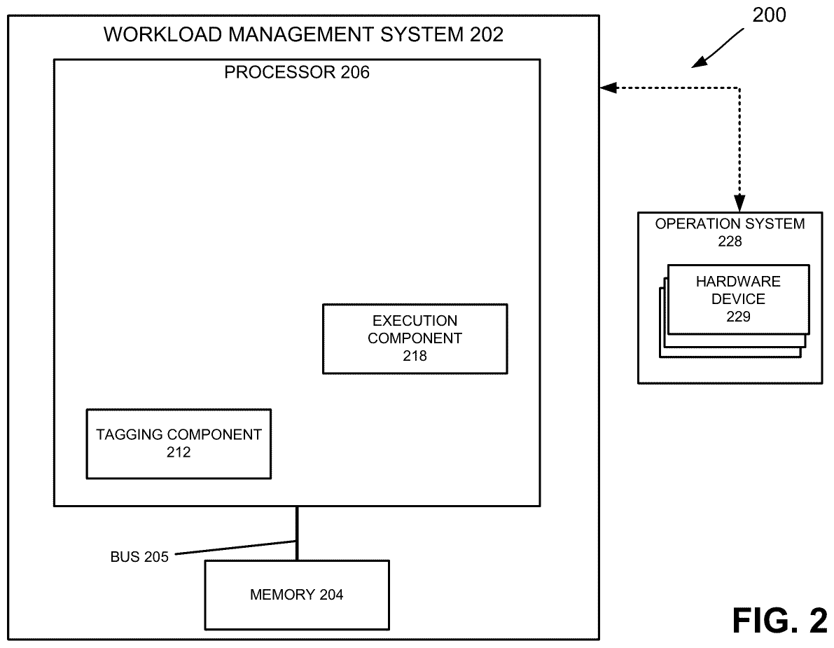

The workload management system 202 can generally monitor and maintain execution of one or more workloads that employ one or more hardware devices 129 of the operation system 128. The workload management system 202 will be described in detail below, relative to FIG. 2.

The operation system 128, the operation management system 102, and the workload management system 202 can be operably coupled by any suitable connection, network, cloud application and/or cloud service.

For example, communication can be by any suitable method. Communication can be facilitated by wired and/or wireless methods including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), ZIGBEE® and other 802.XX wireless technologies and/or legacy telecommunication technologies, BLUETOOTH®, Session Initiation Protocol (SIP), radio frequency for consumer electronics (RF4CE) protocol, wireless highway addressable remote transducer (WirelessHART) protocol, internet protocol version 6 (Ipv6) over Low power Wireless Area Networks (6LoWPAN), Z-Wave, an adaptive network technology (ANT) protocol, an ultra-wideband (UWB) standard/protocol and/or other proprietary and/or non-proprietary communication protocols.

Turning next to FIG. 2, an architecture 200 is illustrated comprising the workload management system 202 and an operation system 228. While referring here to one or more processes, operations, facilitations and/or uses of the non-limiting system architecture 200, description provided herein, above and/or below also can be relevant to one or more other non-limiting system architectures described herein (e.g., 100 and/or 300 Repetitive description of like elements and/or processes employed in respective embodiments is omitted for sake of brevity. Further, the workload management system 202 is described only briefly, with further details of an operation management system instead being provided below relative to the workload management system 302.

As illustrated, the workload management system 202 can be communicatively coupled to the operation system 228 for sending and receiving data therebetween. In one or more embodiments, the workload management system 202 can be comprised by the operation system 228.

Generally the workload management system 202 can manage one or more workloads based on one or more statuses of one or more hardware devices, such as hardware devices 229 of the operation system 228. The workload management system 202 can comprise any suitable computing devices, hardware, software, operating systems, drivers, network interfaces and/or so forth. For example, the workload management system 202 can comprise a processor 206 and a memory 204 communicatively coupled by a bus 205. The processor 206 can comprise an execution component 218 and a tagging component 212. In one or more other embodiments, the execution component 218 and/or the tagging component 212 can be disposed external to the processor 206.

The tagging component can tag a hardware device 229 of the operation system 228 relative to a workload executable at the operation system 228. The hardware device 229 can be employable to execute the workload at the operation system 228. Based on a performance indicator that corresponds to a change in status of the hardware device 229, the execution component 218 can generate business impact data representative of a business impact corresponding to an effect of the change in the status of the hardware device 229 on the execution of the workload. That is, the status of the workload and any change of the workload that is or could be caused by the change in status of the hardware device 229 can be reported, such as to a stakeholder entity having a stake in the workload execution. The performance indicator can be obtained by the workload management system 202 from the operation system 228 by any suitable method.

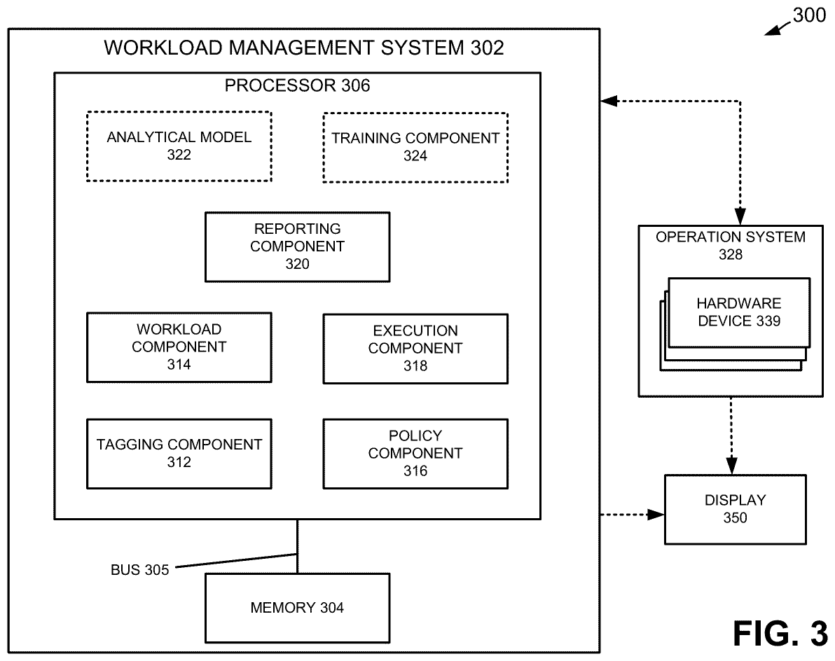

Turning next to FIG. 3, an architecture 300 is illustrated comprising a workload management system 302 that can function to manage a workload executable by an operation system 328 comprising one or more hardware devices 339. While referring here to one or more processes, operations, facilitations and/or uses of the non-limiting system d00, description provided herein, above and/or below also can be relevant to one or more other non-limiting system architectures described herein (e.g., 100 and/or 200 Repetitive description of like elements and/or processes employed in respective embodiments is omitted for sake of brevity.

The operation system 328 can comprise the plurality of hardware devices 339 and one or more processors and/or memories for facilitating functioning of the hardware devices 339. Using one or more of the hardware devices 339, a workload can be executed by the operation system 328. The workload can be fully electronic and/or can comprise a physical component. The workload can comprise output of a digital output, a physical product and/or any other suitable product output. The operation system 328 can comprise one or more computing systems. In one or more cases, the operation system 328 can comprise one or more manufacturing devices, such as assembly-based devices of a product manufacturing line.

A display 350 can be communicatively coupled to the workload management system 302 and/or to the operation system 328 by any suitable method. The display 350 can be associated with a device of a stakeholder entity and/or can be associated with the workload management system 302.

Generally, the workload management system 302 can comprise any suitable computing devices, hardware, software, operating systems, drivers, network interfaces and/or so forth. As illustrated, the workload management system 302 comprises a tagging component 312, policy component 316, workload component 314, execution component 318, reporting component 320, analytical model 322 and/or training component 324. These components can be comprised by a processor 306 and/or one or more of these components can be external to the processor 306. A bus 305 operatively couples the processor 306 and a memory 304.

Communication among the components of the workload management system 302 can be by any suitable method. Communication can be facilitated by wired and/or wireless methods including, but not limited to, employing a cellular network, a WAN (e.g., the Internet), and/or a LAN. Suitable wired or wireless technologies for facilitating the communications can include, without being limited to, Wi-Fi, GSM, UMTS, WiMAX, enhanced GPRS, 3GPPLTE, 3GPP2UMB, HSPA, ZIGBEE®and other 802.XX wireless technologies and/or legacy telecommunication technologies, BLUETOOTH®, SIP, RF4CE protocol, WirelessHART protocol, 6LoWPAN, Z-Wave, an ANT protocol, a UWB standard/protocol and/or other proprietary and/or non-proprietary communication protocols.

Discussion first turns to the processor 306, memory 304 and bus 305 of the workload management system 302.

In one or more embodiments, the workload management system 302 can comprise a processor 306 (e.g., computer processing unit, microprocessor, classical processor and/or like processor). In one or more embodiments, the processor 306 can be and/or be comprised by a controller. In one or more embodiments the controller can be a conflict resolution management (CRM) controller.

In one or more embodiments, a component associated with workload management system 302, as described herein with or without reference to the one or more figures of the one or more embodiments, can comprise one or more computer and/or machine readable, writable and/or executable components and/or instructions that can be executed by processor 306 to facilitate performance of one or more processes defined by such component and/or instruction.

In one or more embodiments, the workload management system 302 can comprise a machine-readable memory 304 that can be operably connected to the processor 306. The memory 304 can store computer-executable instructions that, upon execution by the processor 306, can cause the processor 306 and/or one or more other components of the workload management system 302 to perform one or more actions. In one or more embodiments, the memory 304 can store computer-executable components.

The workload management system 302 and/or a component thereof as described herein, can be communicatively, electrically, operatively, optically and/or otherwise coupled to one another via a bus 305 to perform functions of non-limiting system architecture 300, workload management system 302 and/or one or more components thereof and/or coupled therewith. Bus 305 can comprise one or more of a memory bus, memory controller, peripheral bus, external bus, local bus and/or another type of bus that can employ one or more bus architectures. One or more of these examples of bus 305 can be employed to implement one or more embodiments described herein.

In one or more embodiments, workload management system 302 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the workload management system 302 can reside in the cloud, and/or can reside locally in a local computing environment (e.g., at a specified location).

In addition to the processor 306 and/or memory 304 described above, the workload management system 302 can comprise one or more computer and/or machine readable, writable and/or executable components and/or instructions that, when executed by processor 306, can facilitate performance of one or more operations defined by such component and/or instruction.

Direction first turns to the workload component 314 which can receive, transmit, locate, identify and/or otherwise obtain various data (e.g., including metadata) that can be employed by at least the workload component 314. This data can comprise workload information such as a workload ID, workload type, workload business impact criterion and/or hardware devices and/or resource groups to employ for execution of the workload. Additionally and/or alternatively the data can comprise a description, whether the workload is revenue generating, estimated revenue, financial impact, legal impact, operation impact and/or related contact entity information.

That is, the workload component 314 can tag the workload with a business impact criterion. The tagging can comprise any suitable mapping, labeling, notation, linking and/or the like allowing for the corresponding business impact criterion to be determined upon access to the workload. Such access to the workload can comprise reference to the workload ID and/or review of workload information by accessing the workload management system 302.

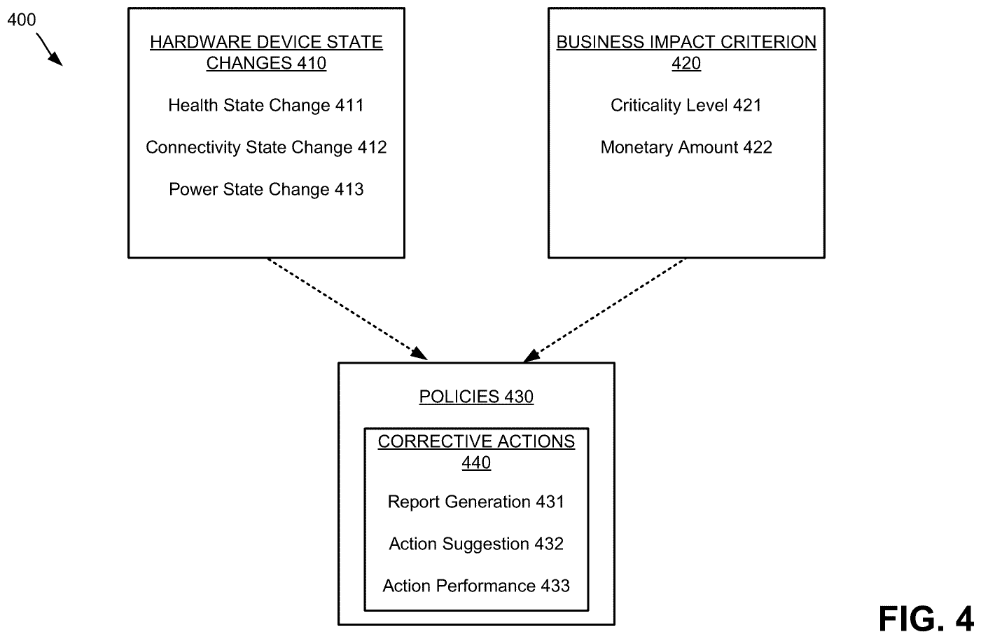

Turning briefly to FIG. 4, in addition to FIG. 3, the business impact criterion 420 can comprise a criticality level 421 and/or a monetary amount 422. The criticality level 421 can be based on any one or more of the estimated impact, financial impact, legal impact and/or operational impact. In one or more embodiments, the criticality level 421 can be broken into high, medium and low indicators and/or catastrophic, critical and warning indicators based on any one or more of the aforementioned impacts. The monetary amount 422 can be based on any one or more of revenue to be generated and/or lost, and/or financial impact. That is, the monetary amount 422 can represent the amount of revenue to be earned and/or lost by completion of execution of the workload.

The business impact criterion 420 can provide for both the criticality level 421 and the monetary amount 422, either the criticality level 421 or the monetary amount 422 separately, and/or an aggregation of the criticality level 421 and the monetary amount 422. An aggregation can comprise any suitable determination of a resultant output level. That is, the business impact criterion 420 can employ a ranking and/or weighting system such as from 0 to 100 or using any other range, numerical, alphabetical or otherwise.

In addition, in one or more embodiments, the workload component 314 can likewise tag (e.g., label) the workload relative to a stakeholder entity that is impacted by the execution of the workload or by a non-execution of the workload. In this way, access to information of the workload at the workload management system 302 can allow for access to contact information (name, phone number, email address, department) of the stakeholder entity. The stakeholder entity can be any suitable entity but need not be an entity having access to the operation system 328 and/or to the hardware devices 339. Examples can comprise an administrating entity and/or executive entity.

Using an output from the workload component 314, the tagging component 312 can tag a hardware device 339 relative to the workload, such as with the workload ID. The tagging component 312 can obtain any one or more aspects of information from the workload component 314 in any suitable manner. The tagging can comprise any suitable mapping, labeling, notation, linking and/or the like allowing for the corresponding business impact criterion to be determined upon access to the workload. Such access to the workload can comprise reference to the business impact criterion 420 and/or review of workload information by accessing the workload management system 302.

In addition, the tagging component 312 can further group one or more hardware devices 339 based on use (cooperative and/or separate) for execution of a same workload. Such resource group can be digital rather than physical. Hardware devices 339 at different factory lines, product lines, locations, departments and/or the like can be comprised by a same resource group. A hardware device 339 can be grouped into one or more resource groups, such as being employed for one or more workloads. That is, the different resources groups can correspond to different workloads. In one or more embodiments, two or more resource groups can be tagged relative to a single workload. That is, the tagging performed by the tagging component 312 can be performed for data of the hardware devices 339 and/or for information of the resource groups that is accessible by the workload management system 302. In this way, access to a hardware device 339 can allow for access to a resource group, and thus also to a workload, by way of the tagging.

In one or more embodiments, a resource group can be represented by a data node, and thus the tagging component 312 can generate the data node and/or merely assign a resource group and/or hardware devices 339 to an existing data node accessible by the workload management system 302.

Direction next turns to the policy component 316 which can generally generate a workload policy 430 based on the business impact criterion 420 and/or a hardware device state change 410 (FIG. 4). These policies can be generally applied to any workload and/or can be specific to one or more workloads. Such information (e.g., mapping) of policies can be provided by the workload component 314 and/or by an administrating entity, such as when submitting information for a new workload to the workload component 314.

Generally, a policy 430 can, based on a change in status of a workload, trigger a non-action or a corrective action. That is, a corrective action can be determined by a policy to address a change in status of a workload (e.g., based on change in status of a hardware device and/or resource group) and/or that addresses an effect of such change. An effect of such change can comprise workload output change, workload speed change, output quality change, resource use change. A resource can comprise money, power, hardware devices, bandwidth, memory and/or the like.

Discussion first turns to determination of status of a workload. The status of a workload can be based on an aggregation of statuses of hardware devices tagged to the workload by the tagging component 312. Generation of a workload status based on hardware device 339 statuses will be explained below, relative to actions performed by the execution component 318.

Based on the status of a workload (e.g., based on a change in status), a policy 430 can be generated to address the status. Statuses of a workload can be broken into any suitable dividers, but not limited to catastrophic (high), critical (medium), warning (low) and operational (no change in status). Accordingly, a first policy 430 can provide for a first corrective action based on a catastrophic status. A second policy 430 can provide for a second corrective action based on a different status.

The corrective action identified in and/or triggered by a policy 430 additionally and/or alternatively can be based on the business impact criterion 420 assigned to the workload. That is, a corrective action assigned can be based on a combination of workload status and the business impact criterion 420. For example, a first business impact criterion 420 ranking of high coupled with a workload status of warning can be linked to a corrective action that is equal to a second business impact criterion 420 ranking of low coupled with a workload status of catastrophic.

In one or more other embodiments, a threshold can be assigned to an amount of change in state (also herein referred to as a status) of a hardware device/resource group, such as where the threshold is satisfied (e.g., met) and an associated workload has a selected business impact criterion 420, a corrective action can be triggered.

That is, more generally, a set of rules-based mappings between business impact criterion 420, workload statuses and corresponding corrective actions can be determined by an administrating entity and entered into the workload management system 302, such as by access to the policy component 316 (e.g., policy engine).

Description now turns to the corrective actions 440 that can be identified in a policy 430. The corrective actions 440 can comprise a report generation 431, action suggestion 432 and/or an action performance 433. One or more corrective actions 440 can be specified by a policy, such as a report generation 431 and one of an action suggestion 432 or an action performance 433.

A report generation 431 can comprise generation by the execution component 318 of a report representative of a status of a workload and can comprise information providing a notification of the status and/or of an effect of a change in execution (e.g., a reduction in execution) of the workload such as caused by the change in status of the workload (e.g., based on a change in status of a resource group and/or hardware device 339). The information additionally and/or alternatively can comprise information representative of a present impact of a change in status of a hardware device and/or resource group and/or predicted impact of continued effect of the change in the status of the hardware device or the resource group on the workload. The information additionally and/or alternatively can comprise downtime estimation, downtime cost estimation and/or time to full efficiency and/or performance of a workload.

That is, the report generation 431 itself can provide data that can allow for proactive action to be taken relative to workload status that otherwise would not be available by the operation system 328. Indeed, such proactive information can assist in the continued execution of the workload prior to occurrence of a predicted failure and/or reduction of the execution of the workload, such as due to a further change in status of a hardware device 339 and/or resource group.

An action suggestion 432 can comprise a suggestion for swapping of a hardware device 339 between workloads, replacement of a hardware device 339, swapping of resource groups between workloads, change in power supply, change to increase connectivity, increase in storage, change in workload execution speed, workload migration and/or the like. It is noted that the workload management system 302 can serve to monitor and manage a workload but may not serve as a full workload manager. That is, information regarding a workload can be provided by the workload management system 302 to bridge the gap between desired workload output and mere hardware resource status. However, workload migration and other actions may merely be suggested as an action suggestion 432 rather than implemented by the workload management system 302.

An action performance 433 can comprise ordering a part for a hardware device 339, tagging a hardware device 339 to the workload (e.g., cooperatively performing such action with the tagging component 312) and/or changing power supply to a hardware device 339. That is, such actions can be lesser actions that can be made absent administrator entity involvement with the operation system 328.

In one or more embodiments, a policy 430 can be predicated on a corrective action output of a workload having a higher ranking. For example, a policy can be generated for issuing a report generation 431 for a second workload based on a particular corrective action 440 having been taken for a first workload. Such correspondence between the first workload and second workload can be due to use of a same hardware device 339 and/or resource group and/or due to a business effect of one workload on the other. That is, the workload management system 303 can be reactive more than to mere status of a hardware device and its operation in a vacuum apart from any workload execution.

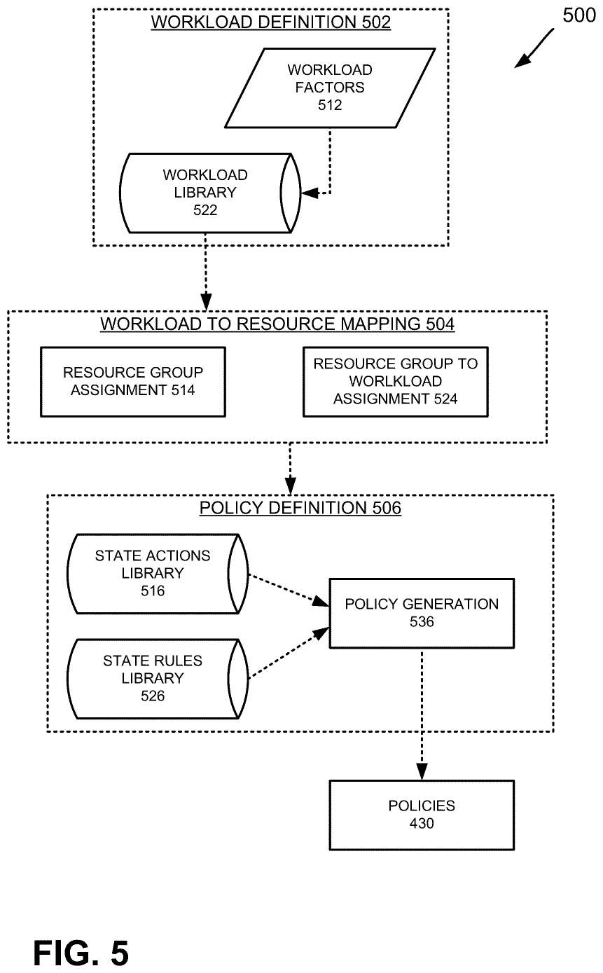

Turning next briefly to FIG. 5, a summary of policy generation is provided at the process flow 500 illustrated. That is, workload definition 502 can comprise any one or more workload factors 512 being logged at a workload library 522. The workload factors 512 can comprise any one or more aspects of data representative of the workload ID, workload type, workload business impact criterion, hardware devices and/or resource groups to employ for execution of the workload, general workload description, whether the workload is revenue generating, estimated revenue, financial impact, legal impact, operation impact and/or related contact entity information. This logging can be facilitated by the workload component 314.

The tagging component 312 can facilitate workload to resource mapping 504 using the workload library 522. The mapping 504 can comprise resource group assignment 514 comprising assignment of one or more hardware devices 339 to a resource group. The mapping 504 can also comprise resource group to workload assignment 524 as discussed above.

Next, the policy component 316 can facilitate policy definition 506. A state actions library 516 and a state rules library 526 can be employed to provide for the mapping between hardware device state changes 410, business impact criterion 420 and policies 430, referred to generally as policy generation 536. As a result, one or more policies 430 can be output for use by the execution component 318.

Turning now to the execution component 318, statuses and change in statuses of a hardware device 339 can be obtained in any suitable manner by the workload management system 302 from the operation system 228. The statuses can be classified by the execution component 318 as a hardware device state change 410. Such hardware device state changes 410 that can be monitored by the execution component 318 can comprise a health state change 411, a connectivity state change 412 and/or a power state change 413. A health state change 411 can be based on the operational functionality of a hardware device 339. A connectivity state change 412 can be based on communicative function of and/or with a hardware device 339. A power state change 413 can be based on power used by and/or able to be supplied to a hardware device 339.

For each hardware device 339, any one or more of a health state change 411, connectivity state change 412 and/or power state change 413 can be aggregated into an overall hardware device state change 410.

For each resource group comprising one or more hardware devices 339, any one or more health state change 411, connectivity state change 412 and/or power state change 413 of one or more hardware devices 339 can be aggregated into a resource group state change.

In response to obtaining notification of any one or more of the various above-mentioned state changes, the execution component 318 can determine a workload status based on at least the resource group status. Particular mapping between any one or more of the various above-mentioned state changes and a workload status can be provided by an administrator entity, such as by communicating data representative of such mapping to the execution component 318, processor 306 and/or workload management system 302 generally.

Subsequently to determination of a workload status change, based on the rules-based mappings of workload status, policies 430 and associated corrective actions 440 discussed above relative to the policy component 316, the execution component 318 can determine a corrective action 440 to address a change in status of the workload or an effect of a change in status of a workload, either caused by a change in status of a hardware device 339 and/or resource group.

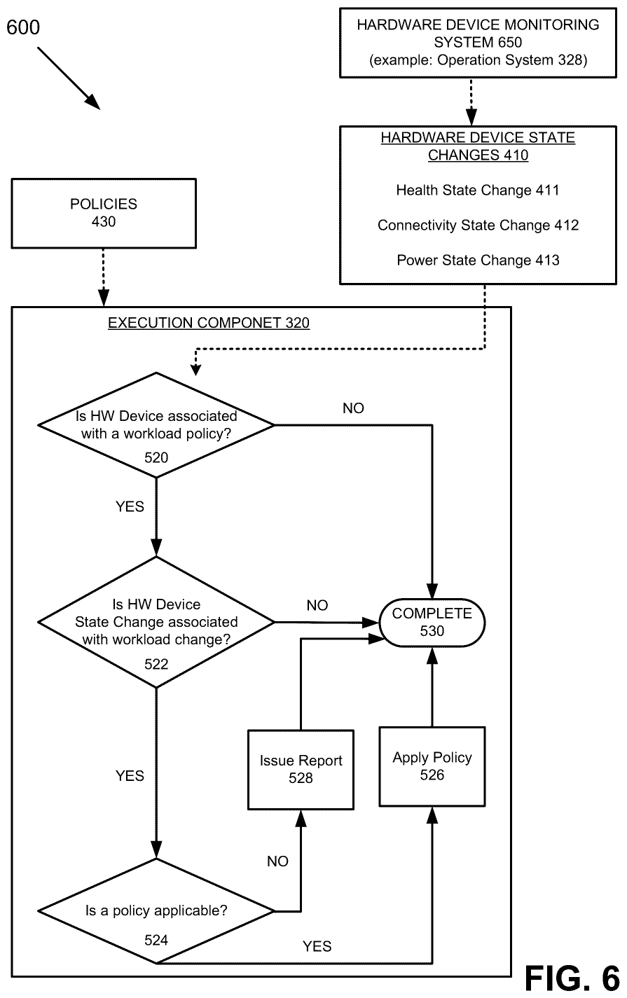

Turning next briefly to FIG. 6, a summary of policy execution and corrective action execution is provided at the process flow 600 illustrated. The execution component 318 can employ the policies 430 and any information provided by a hardware device monitoring system 650, such as the operation system 328) to determine if a corrective action 440 should be applied and what corrective action 440 should be applied.

For example, the execution component 318 can first determine at decision step 520 if a hardware device 339 (for which a state change 410 was obtained) is associated with a workload policy 430 or workload. If the answer is no, the process flow 600 is complete at end box 530. If the answer is yes, the process flow 600 proceeds to decision step 522.

At decision step 522, the execution component 318 can determine if a hardware device state change 410 is associated with a workload status change. If the answer is no, the process flow 600 is complete at end box 530. If the answer is yes, the process flow 600 proceeds to decision step 524.

At decision step 524, the execution component 318 can determine if a policy 430 generated by the policy component 316 (e.g., as an output to the process flow 500) is applicable to the hardware device state change 410 (e.g., to a workload status change caused by the hardware device state change 410). If the answer is no, the process flow 600 can proceed to issue a report at step 528, such as to notify a stakeholder entity of the state/status change and that no currently-available policy 430 was applicable. In this way, the stakeholder entity can either proceed to cause generation of a new policy 430, modify a policy 430, or take appropriate action part from the workload management system 302. If the answer is yes, the process flow 600 proceeds to apply a policy 430 at step 526, and then can proceed to process completion at end box 530.

Turning again to FIG. 3, and particularly to the reporting component 320, this component can communicate with a device associated with the stakeholder entity, a device associated with the operation system 328 and/or a device associated with the workload management system 302 to cause information to be communicated. This information can comprise information of a report generation 431, action suggestion 432, report of an action performance 433 having been performed and/or being performed, and/or any other notification, warning and/or the like of workload status. In one or more embodiments, the reporting component 320 can cause such information to be rendered via a display 350 which can be associated with and/or electronically coupled to any of a device associated with the stakeholder entity, a device associated with the operation system 328 and/or a device associated with the workload management system 302.

Referring still to FIG. 3, in one or more embodiments, the workload management system 402 can comprise an analytical model 322. The analytical model 322 can be, can comprise and/or can be comprised by a classical model, such as a predictive model, neural network, and/or artificial intelligence (AI) model. An artificial intelligent model and/or neural network (e.g., a convolutional network and/or deep neural network) can comprise and/or employ AI, machine learning (ML), and/or deep learning (DL), where the learning can be supervised, semi-supervised, self-supervised, semi-self-supervised and/or unsupervised. For example, the analytical model 322 can comprise an ML model.

The analytical model 322 generally can evaluate known data, such as historical data from an external source and/or newly available (e.g., real-time data) representative of hardware device 339 states, resource group states and/or workload states. In one or more cases, the analytical model 322 can aid the policy component 316 in determining mapping between hardware device state changes 410, business impact criterion 420 and corrective actions 440 that can result from an aggregation thereof. In one or more cases, the analytical model 322 can aid the execution component 318 by determining a corrective action 440 to correspond to a workload state change, such as at least partially based on the associated business impact criterion 420, such as based on realtime updated data rather than only on a rules-based mapping between hardware device state changes 410, business impact criterion 420 and corrective actions 440.

Alternatively, it will be appreciated that the workload management system 302 can function absent use of the analytical model 322.

Where in use, the analytical model 322 can be trained, such as by a training component 324, on a set of training data that can represent the type of data for which the workload management system 302 will be used. That is, the analytical model 322 can be trained on historical and/or current data comprising hardware device 339 states, resource group states and/or workload states and/or on any one or more of component parameters, capabilities, configurations and descriptions, workload descriptions, availability of resources, configurations and/or impact assessments.

### Example Reporting

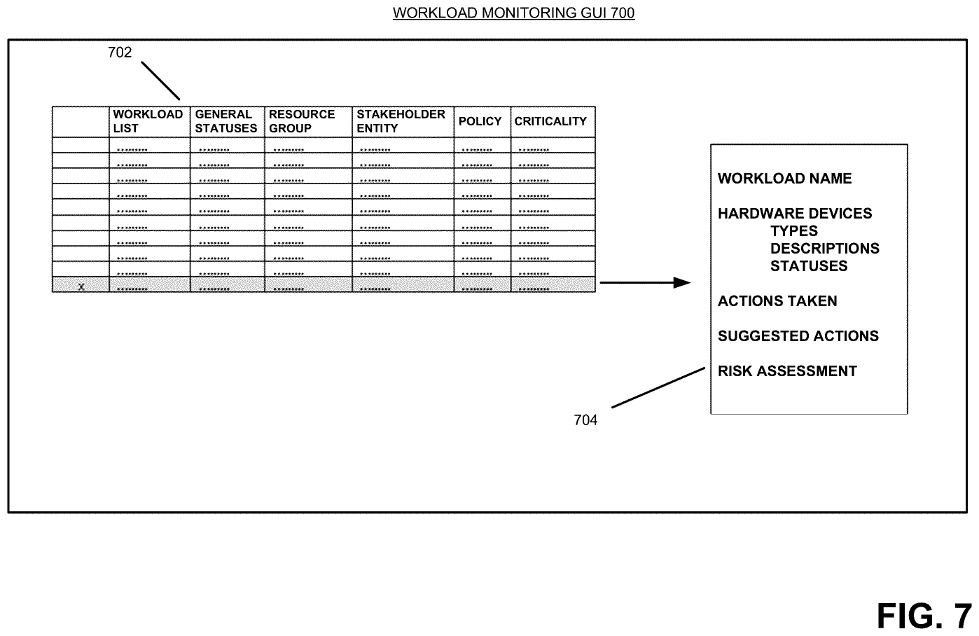

Referring now briefly to FIG. 7, an example graphical user interface 700, such as a workload dashboard is illustrated. The GUI 700 is representative of but one example of how information attained by the workload management system 302 can be rendered by the reporting component 320 for use by a stakeholder entity. In one or more embodiments, the GUI 700 can be displayed at the display 350 discussed above.

Generally, a workload dashboard can allow for any one or more of creation/deletion/modification of a workload, enabling/disabling monitoring of a workload, associating of a policy 430 to a workload and/or monitoring of a workload. In one or more embodiments, a workload dashboard can allow for access to the policy component 316 such as for creation/deletion/modification of a workload policy 430 that can be assigned to a workload.

As illustrated, the GUI 700 can provide for at least a workload tracking 702. The workload tracking 702 can comprise a workload list, workload statuses, resource group assigned, stakeholder entity, policies associated with the workload and/or criticality level 421 assigned to the workload.

By selecting a workload from the workload tracking 702, additional workload-specific information 704 can be provided. This workload-specific information 704 can comprise, but is not limited to, workload name, hardware devices (types, descriptions, statuses) associated with the workload, actions having already been taken, actions suggested and/or data representative of a risk assessment based on current workload status.

### Example Operations

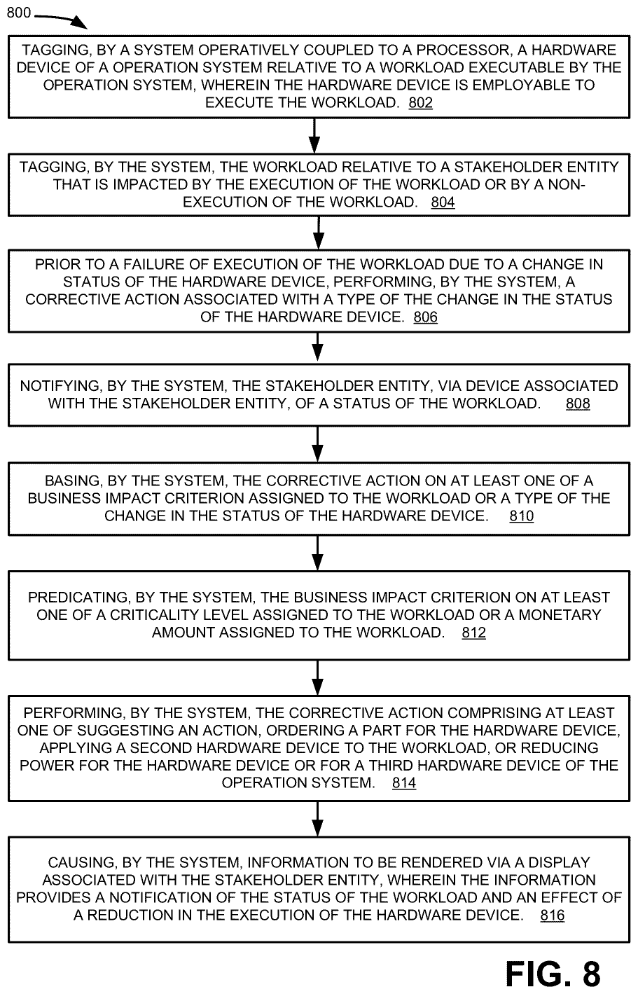

Turning now to FIG. 8, a process flow comprising a set of operations for managing hardware device health related to a workload that is executable at an operation system is set forth relative to FIGS. 1-7. One or more elements, objects and/or components referenced in the process flow 800 can be those of schematics 100-700. While the process flow 800 references one or more aspects of the workload management system 302 of FIG. 3, the process flow 800 is likewise applicable to the workload management system 103 of FIG. 1 and the workload management system 202 of FIG. 2. Repetitive description of like elements and/or processes employed in respective embodiments is omitted for sake of brevity.

At operation 802, the process flow 800 can comprise tagging, by a system operatively coupled to a processor (e.g., tagging component 312), relative to a workload executable by an operation system, a hardware device of the operation system, which hardware device is employable to execute the workload.

At operation 804, the process flow 800 can comprise labeling, by the system (e.g., workload component 314), a stakeholder entity that is impacted by the execution of the workload or by a non-execution of the workload.

At operation 806, the process flow 800 can comprise prior to a failure of execution of the workload due to a change in status of the hardware device, performing, by the system (e.g., execution component 318), a corrective action associated with a type of the change in the status of the hardware device.

At operation 808, the process flow 800 can comprise notifying, by the system (e.g., reporting component 320), the stakeholder entity, via a device associated with the stakeholder entity, of a status of the workload.

At operation 810, the process flow 800 can comprise basing, by the system (e.g., policy component 316), the corrective action on at least one of a business impact criterion assigned to the workload or a type of the change in the status of the hardware device.

At operation 812, the process flow 800 can comprise predicating, by the system (e.g., workload component 314), the business impact criterion on at least one of a criticality level assigned to the workload or a monetary amount assigned to the workload.

At operation 814, the process flow 800 can comprise performing, by the system (e.g., execution component 318), the corrective action comprising at least one of suggesting an action, ordering a part for the hardware device, applying a second hardware device to the workload, or reducing power for the hardware device or for a third hardware device of the operation system.

At operation 816, the process flow 800 can comprise causing, by the system (e.g., reporting component 320), information to be rendered via a display associated with the stakeholder entity, wherein the information provides a notification of the status of the workload and an effect of a reduction in the execution of the workload caused by the change in the status of the workload.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of the FIGS. provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, technology described herein relates to managing hardware device health related to a workload that is executable at an operation system. A system can comprise a processor, and a memory that stores executable instructions that, when executed by the processor, facilitate performance of operations, comprising tagging a hardware device of an operation system relative to a workload executable at the operation system, wherein the hardware device is employable to execute the workload at the operation system, and based on a performance indicator that corresponds to a change in status of the hardware device, generating business impact data representative of a business impact corresponding to an effect of the change in the status of the hardware device on the execution of the workload.

An advantage of one or more of the above-indicated method, system and/or non-transitory computer-readable medium can be an enhancement to hardware health monitoring and management to better understand business and/or cost implications of hardware issues on business-critical workloads. In this way, execution of a workload can be tracked separately from mere discrete tracking of individual hardware devices.

Another advantage of one or more of the above-indicated method, system and/or non-transitory computer-readable medium can be proactive notification of a change in status of a workload, relative to one or more hardware devices of an operation system supporting the workload. In this way, a workload's health, and not merely discrete health statuses of hardware devices, can be tracked prior to catastrophic failure of a workload.

Still another advantage of one or more of the above-indicated method, system and/or non-transitory computer-readable medium can be allowance of tracking of a status of a workload by an entity lacking access to hardware management of hardware devices being employed to execute the workload. Indeed, a stakeholder entity can be a business professional or management professional having no access to the operation system or to the execution of the workload. As a result, such stakeholder entity can be able to track the health and/or performance of the workload, even absent any understanding of the hardware devices being employed to execute the workload.

Yet another advantage of one or more of the above-indicated method, system and/or non-transitory computer-readable medium generation of one or more policies for addressing a hardware device issue. The policy can be based on one or more workloads employing the hardware device, rather than merely on the hardware device itself. That is, such policies can be determined outside of a vacuum of mere hardware support/management only.

Another advantage of one or more of the above-indicated method, system and/or non-transitory computer-readable medium can be application of a corrective action for addressing overall workload status that would not have been realized through tracking of hardware device basis only. For example, consider that a first hardware device has been damaged catastrophically.

By tracking only hardware devices, absent concern of workload relation, the first hardware device would be replaced with another hardware device. However, where tracking workload status, it may instead be realized that an alternative solution can be available. For example, a first resource group of hardware devices, including the first hardware device and assigned to the first workload, can be swapped with a second resource group of hardware devices assigned to the second workload, such as where the second workload does not employ usage of the damaged first hardware device.

Indeed, in view of the one or more embodiments described herein, a practical application of above-indicated method, system and/or non-transitory computer-readable medium can be an ability to maintain functioning of a workload by monitoring related hardware devices, such as prior to catastrophic stoppage of execution of the workload. This can be possible by providing an overall status of the workload based on an aggregation of statuses of various hardware devices being employed and/or employable for executing the workload. Indeed, as opposed to individually tracking each hardware device absent understanding of overall purpose relative to one or more workloads, focus can be provided to overall workload status in a proactive manner. This is a useful and practical application of computers, thus providing enhanced (e.g., improved and/or optimized) operation of the hardware and/or software components for executing a workload. Overall, such tools can constitute a concrete and tangible technical and/or physical improvement in the field of workload management.

Furthermore, one or more embodiments described herein can be employed in a real-world system based on the disclosed teachings. For example, one or more electronic structure embodiments described herein can function with a resource group of hardware devices that can provide as output their statuses and performance statistics. Such information can be employed by a workload management system described herein to maintain execution of a workload by executing one or more workload-based policies (as opposed to hardware device-only-based policies) for one or more hardware devices of the resource group.

Moreover, a system and/or method described herein can be implemented in one or more domains to enable scaled filtering. Indeed, inputs can be received relative to a plurality of resource groups and/or outputs (e.g., policies and/or corrective actions) can be provided relative to a plurality of workloads at least partially in parallel with one another.

Further, one or more embodiments described herein are inherently and/or inextricably tied to computer technology and cannot be implemented outside of a computing environment. For example, one or more processes performed by one or more embodiments described herein can more efficiently, and even more feasibly, generate and apply workload-based policies and corresponding workload-based corrective actions as compared to existing systems and/or techniques. Systems, computer-implemented methods and/or computer program products facilitating performance of these processes are of great utility in the field of workload management and cannot be equally practicably implemented in a sensible way outside of a computing environment. Indeed, inputs and/or outputs of a system and/or method described herein can be digitally/electronically communicated.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively dynamically coordinate electronic signals from a plurality of hardware devices and apply workload-based policies and corrective actions for the plurality of hardware devices as the one or more embodiments described herein can facilitate these processes. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud operation systems, computer architecture and/or another technology.

One or more embodiments described herein can be fully operational towards performing one or more other functions (e.g., fully powered on, fully executed and/or another function) while also performing the one or more operations described herein.

### Example Operating Environment

FIG. 9 is a schematic block diagram of an operating environment 900 with which the described subject matter can interact. The operating environment 900 comprises one or more remote component(s) 910. The remote component(s) 910 can be hardware and/or software (e.g., threads, processes, computing devices). In one or more embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The operating environment 900 also comprises one or more local component(s) 920. The local component(s) 920 can be hardware and/or software (e.g., threads, processes, computing devices). In one or more embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The operating environment 900 comprises a communication framework 940 that can be employed to facilitate communications between the remote component(s) 910 and the local component(s) 920, and can comprise an air interface, e.g., interface of a UMTS network, via a LTE network, etc. Remote component(s) 910 can be operably connected to one or more remote data store(s) 950, such as a hard drive, solid state drive, subscriber identity module (SIM) card, electronic SIM (eSIM), device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

### Example Computing Environment

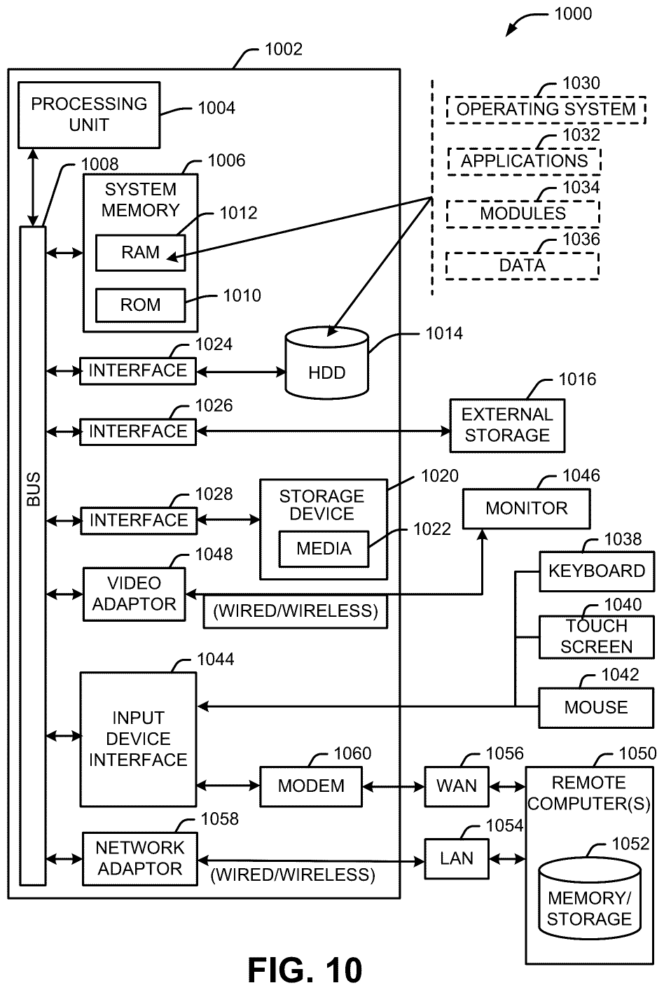

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 10, the example computing environment 1000 which can implement one or more embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in computing environment 1000, a solid-state drive (SSD) could be used in addition to, or in place of, an HDD 1014.

Other internal or external storage can include at least one other storage device 1020 with storage media 1022 (e.g., a solid-state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer 1050. The remote computer 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. The network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
a processor; and
a memory that stores executable instructions that, when executed by the processor, facilitate performance of operations, comprising:
tagging a hardware device of an operation system relative to a workload executable at the operation system, wherein the hardware device is employable to execute the workload at the operation system; and
based on a performance indicator that corresponds to a change in status of the hardware device, generating business impact data representative of a business impact corresponding to an effect of the change in the status of the hardware device on the execution of the workload.

2. The system of claim 1, wherein the business impact data comprises present impact data representative of a present impact of the change in the status of the hardware device and predicted impact data representative of a predicted impact of continued effect of the change in the status of the hardware device on the workload.

3. The system of claim 1, wherein the operations further comprise:
tagging the workload with a criticality level assigned to the workload, wherein the business impact data comprises predicted impact data representative of a predicted impact of failure to execute the workload based on the criticality level.

4. The system of claim 1, wherein the hardware device is a first hardware device, and wherein the operations further comprise:
grouping together, in a group, the first hardware device and a second hardware device, of the operation system, based on use of the first hardware device and the second hardware device for execution of the workload at the operation system; and
applying a workload policy to the group based on a criticality level assigned to the workload.

5. The system of claim 1, wherein the operations further comprise:
determining a corrective action that addresses the change in the status of the hardware device or that addresses the effect of the change in the status of the hardware device on an execution of the workload.

6. The system of claim 5, wherein the corrective action comprises at least one of suggesting an action, ordering a part for the hardware device, applying a second hardware device of the operation system to the workload, or reducing power for the hardware device or for a third hardware device of the operation system.

7. The system of claim 5, wherein the corrective action is based on at least one of a criticality level assigned to the workload or a monetary amount associated with the workload.

8. The system of claim 1, wherein the operations further comprise:
generating suggestion data representative of a proactive suggestion to perform a corrective action that facilitates maintaining execution of the workload prior to occurrence of a predicted failure of the execution of the workload due to a further change in the status of the hardware device.

9. A computer-implemented method, comprising:
tagging, by a system operatively coupled to a processor, a hardware device of an operation system relative to the workload executable by an operation system, wherein the hardware device is employable to execute the workload; and
prior to a failure of execution of the workload due to a change in status of the hardware device, performing, by the system, a corrective action associated with a type of the change in the status of the hardware device, wherein performing the corrective action maintains the execution of the workload.

10. The computer-implemented method of claim 9, further comprising:
labeling, by the system, the workload relative to a stakeholder entity that is impacted by the execution of the workload or by a non-execution of the workload,
wherein performing the corrective action comprises notifying the stakeholder entity, via a device associated with the stakeholder entity, of a status of the workload.

11. The computer-implemented method of claim 9, wherein the corrective action is based on at least one of a business impact criterion assigned to the workload or a type of the change in the status of the hardware device.

12. The computer-implemented method of claim 11, wherein the business impact criterion is predicated on at least one of a criticality level assigned to the workload or a monetary amount assigned to the workload.

13. The computer-implemented method of claim 9, wherein performing the corrective action comprises at least one of suggesting an action, ordering a part for the hardware device, applying another hardware device to the workload, or reducing power for the hardware device or another hardware device, of the operation system, assigned to the workload.

14. The computer-implemented method of claim 10, further comprising:
causing, by the system, information to be rendered via a display associated with the stakeholder entity, wherein the information provides a notification of the status of the workload and of an effect of a reduction in the execution of the workload caused by the change in the status of the hardware device.

15. A non-transitory machine-readable medium, comprising executable instructions that, when executed by a processor facilitate performance of operations, comprising:
weighting a first workload for execution at an operation system, as compared to a second workload for execution at the operation system,
wherein the weighting of the first workload is based on a business impact criterion for the first workload, and wherein the business impact criterion comprises a criticality level of the first workload or a monetary amount assigned to the first workload; and
generating a status report representative of a status of the first workload and comprising a suggested action for the execution of the first workload, wherein the suggested action is based on a weight of the first workload resulting from the weighting of the first workload.

16. The non-transitory machine-readable medium of claim 15, wherein the operations, the performance of which is facilitated by the processor, further comprise:
identifying a hardware device of the operation system that is employed to execute the first workload; and
triggering the generating of the status report based on a present status of the hardware device.

17. The non-transitory machine-readable medium of claim 16, wherein the triggering of the generating of the status report is based on the present status of the hardware device being determined to satisfy a hardware device status threshold, and wherein the hardware device status threshold is based at least partially on the business impact criterion for the first workload.

18. The non-transitory machine-readable medium of claim 15, wherein the operations, the performance of which is facilitated by the processor, further comprise:
generating action data representative of a corrective action, wherein the generating of the action data is triggered by a present status of a hardware device of the operation system, which hardware device is employed to execute the first workload.

19. The non-transitory machine-readable medium of claim 15, wherein the operations, the performance of which is facilitated by the processor, further comprise:
identifying a first hardware device of the operation system that is employed to execute the first workload;
identifying a second hardware device of the operation system that is employed to execute the first workload;
grouping, into a resource group, the first hardware device with the second hardware device based on employment of both the first hardware device and the second hardware device to execute the first workload; and
generating a policy for maintaining of the execution of the first workload, which policy affects the resource group.

20. The non-transitory machine-readable medium of claim 15, wherein the operations, the performance of which is facilitated by the processor, further comprise:
generating a status report representative of a status of the second workload and comprising a suggested action for the execution of the second workload, wherein the generating of the status report for the second workload is triggered based on the status of the first workload.
